(19) United States
(12) Patent Application Publication
(10) Pub. No.: US 2017/0046055 A1
(43) Pub. Date: Feb. 16, 2017

(54) DATA VISUALIZATION IN A TILE-BASED GRAPHICAL USER INTERFACE

(71) Applicant: SAP SE, Walldorf (DE)

(72) Inventors: Tejram Jagannath Sonwane, Bangalore (IN); Prasanna Bhat Mavinakuli, Sagar (IN)

(21) Appl. No.: 14/823,004

(22) Filed: Aug. 11, 2015

(51) Int. Cl. G06F 3/0484; G06F 17/30; G06F 3/0482

(52) U.S. Cl. CPC G06F 3/04847; G06F 3/0482; G06F 17/30011; G06F 17/30265

(57) ABSTRACT

Various embodiments of systems and methods to provide data visualization in a tile-based graphical user interface are described herein. In one aspect, a document to be rendered based upon a query is retrieved. A plurality of infographics is extracted from an information object associated with the document Further, ranks for the plurality of infographics are determined based on attributes of the plurality of infographics and corresponding boosting values. The plurality of infographics is rendered in an order based on the determined ranks in a tile of the tile-based graphical user interface.

### FIELD

Embodiments generally relate to computer systems, and more particular to methods and systems to provide data visualization in a tile-based graphical user interface.

### BACKGROUND

The reporting, analysis, and interpretation of business data is of central importance to an organization to support accurate and timely organization decisions and thus achieving its competitive edge and optimizing processes. For example, data analysts create and add data in a data repository on a daily basis. End-users with access to the data repository may search for certain data. However, analyzing relevant data in a large volume of data can be a challenge. Data visualization tools allow retrieving and visualizing desired data. However, these tools can be limited to a way in which the data is rendered. For example, these tools render a list of relevant documents (e.g., in a form of a table) for a query and the user may have to open a document to search for desired data. Opening each document in a large volume of documents to find desired data may not be an efficient and robust mechanism.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a computing environment illustrating a special purpose computing system configured to provide data visualization in a tile-based graphical user interface (GUI), according to an embodiment.

FIG. 2 is a flow diagram illustrating an example process to provide data visualization in a tile-based graphical user interface, according to an embodiment.

FIG. 3 is a flow diagram illustrating an example process to obtain infographics in an information object, according to an embodiment.

FIG. 4 is a schematic diagram illustrating exemplary infographics associated with a document, according to an embodiment.

FIG. 5A is a schematic diagram illustrating an exemplary tile in a graphical user interface (GUI) displaying infographics based on ranks, according to an embodiment.

FIG. 5B is a schematic diagram illustrating an exemplary tile in a graphical user interface (GUI) displaying infographics based on ranks, according to an embodiment.

FIG. 6 is a schematic diagram illustrating an exemplary graphical user interface (GUI) displaying data based on a query, according to an embodiment.

FIG. 7 is a block diagram of an exemplary computer system, according to an embodiment.

### DETAILED DESCRIPTION

Embodiments of techniques to provide data visualization in a tile-based graphical user interface are described herein. Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

The technologies described herein can be used for accessing data or information in a database platform or a data repository. Adoption of the technologies can provide efficient access to the data in both transactional (e.g., previously created data) and analytical scenarios (e.g., created new data or update existing data) while allowing both data analysts as well as end users (e.g., customers) the flexibility to efficiently access and manage the data.

As used herein, the term “data” can include analytics data, such as created analytics reports or other artifacts created by enterprise database suites (e.g., SAP®'s Crystal Reports, Lumira Datasets, WEBI reports, XCelcius reports and the like). The technologies can accommodate other, arbitrary data such as, but limited to spreadsheets and images.

As used herein, the term “assessing the repository” can include the connection established between a client device (e.g., an access terminal) and one or more database servers (i.e., data repositories) hosting at least one database. In this regard, the database connection may include information identifying a database (e.g., a server address and logon properties of a database), information identifying a subset of a database (e.g., fields, calculations, filters, groupings, or the like), information identifying a database query, and/or information identifying a data cube (e.g., identifying information may include a server address and a technical name of a cube). The database connections may be associated with one or more fields, which may be used to further distinguish and/or classify the data for a given database connection.

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. A second step is required to follow a first step when the first step is completed before the second step is begun. Such a situation will be specifically pointed out when not clear from the context. A particular step may be omitted; a particular step is required only when its omission would materially impact another step.

In this document, the terms “and”, “or” and “and/or” are used. Such terms are to be read as having the same meaning; that is, inclusively. For example, “A and B” may mean at least the following: “both A and B”, “only A”, “only B”, “at least both A and B.” As another example, “A or B” may mean at least the following: “only A”, “only B”, “both A and B”, “at least both A and B.” When an exclusive-or is intended, such will be specifically noted (e.g., “either A. or B”, “at most one of A and B”).

In this document, various computer-implemented methods, processes and procedures are described. It is to be understood that the various actions (receiving, storing, retrieving, displaying, etc.) are performed by a hardware device, even if the action may be authorized, initiated or triggered by a user, or even if the hardware device is controlled by a computer program, software, firmware, and the like. Further, it is to be understood that the hardware device is operating on data, even if the data may represent concepts or real-world objects, thus the explicit labeling as “data” as such is omitted. For example, when the hardware device is described as “storing a document”, it is to be understood that the hardware device is storing data that represents the document.

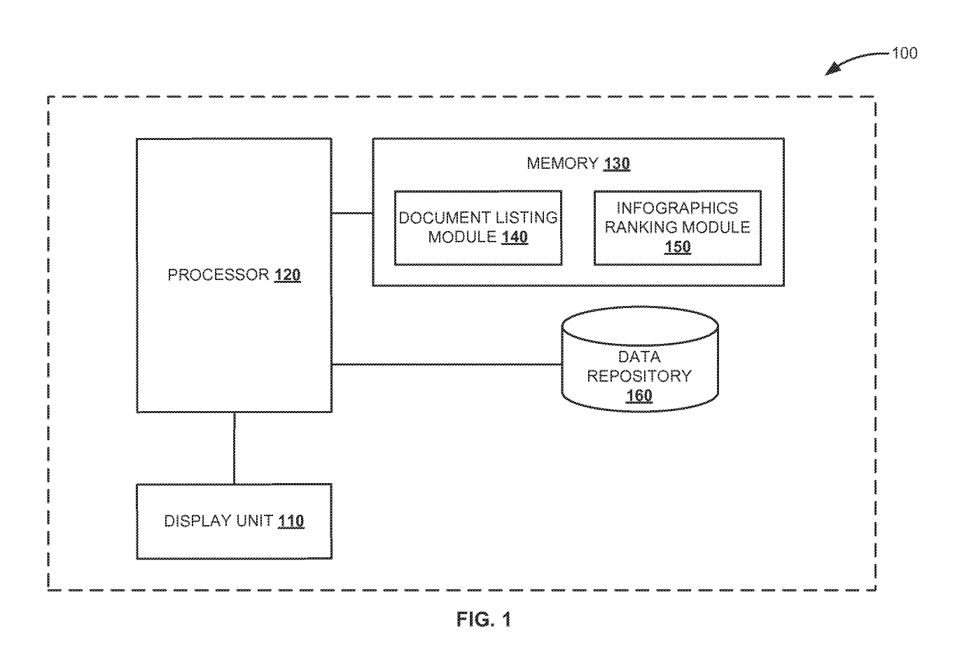

FIG. 1 is a block diagram of a computing environment illustrating special purpose computing system 100 configured to provide data visualization in a tile-based graphical user interface (GUI), according to an embodiment. The computing system 100 can include a computing device such as a desktop computer, a laptop computer, a. handheld computer, a tablet computer, a personal digital assistant (PDA), a cellular telephone, a network appliance, a camera, a smart phone, an enhanced general packet radio service (EGPRS) mobile phone, a media player, a navigation device; an email device, a game console, or an appropriate combination of any two or more of these devices or other data processing devices.

The computing system 100 includes a memory 130 and a processor 120 to execute instructions stored in the memory 130. The processor 120 or “CPU” is in electronic communication with a non-transitory computer-readable storage medium (e.g., memory 130) through a high speed memory bus, for instance. In one exemplary embodiment, the computer-readable storage medium is stored thereon code. Further, the code may be configured to reference data stored in a database of the non-transitory computer-readable storage medium, for example as may be present locally or in a remote database server. Software servers together may form a cluster or logical network of computer systems programmed with software programs that communicate with each other and work together in order to process requests. In one exemplary embodiment, the processor 120 may reside in the computing system 100. In another exemplary embodiment, the processor 120 may reside in other remote computing system.

The processor 120 executes the instructions stored in the memory 130 by accessing relevant data stored in data repository 160. In one embodiment, the memory 130 includes document listing module 140 and infographics ranking module 150, which can be modules of computer program instructions to provide data visualization in the tile-based GUI. Further, the GUI can be rendered through display unit 110.

The document listing module 140 and the infographics ranking module 150 may, depending upon the implementation, be part of a user device, an application, another application, a module of the server or another computer system. Additionally, it should be understood that the document listing module 140 and the infographics ranking module 150 can be implemented on another device rather than on the user device. For example, the document listing module 140 and the infographics ranking module 150 can be implemented on the user device such as a personal computer, tablet, cell phone or other mobile device, to provide data visualization in the tile-based GUI and then performs the various processes described below for generating and displaying the GUI The GUI provides an interface for a user to interact with the processor 120 with touch input and/or a keyboard. The behavior of the GUI may be governed by computer executable instructions that are executed when the user interacts with the GUI.

In one exemplary embodiment, the document is stored as an object in the data repository 160. The document can be a report (e.g., a business intelligence report), which includes multiple visualizations or infographics to understand and analyze the data. Further, the infographics of the document are extracted and stored in an information object corresponding to the object, in some examples, the infographics or visualization snapshots can include tables, graphs, histograms and/or any other visual representation of data associated with the document. Further, the information object stored in the data repository 160 is accessed for generation of data visualization.

The document listing module 140 of the computing system 100 executes data visualization software that identifies relevant documents from the data repository 160 based upon a query to retrieve certain data. In an exemplary embodiment, a user who provides a request to access the documents can include a data analyst of the organization or a department of the organization (e.g., warehouse) or an end user.

In one embodiment, infographics associated with each document identified by the document listing module 140 are retrieved. Further, the infographics associated with each document are ranked by the document ranking module 150. Based on the ranking, the infographics are displayed in a tile-based graphical user interface (GUI). Therefore by displaying infographics of the document, the data analyst or the end user may visualize or analyze the content of the document without opening the document.

In one embodiment, the file-based GUI may be used for concurrent access to multiple documents at a time on the computing system 100. For example, the display unit 110 of the computing system 100 displays multiple tiles and each tile represents a document by displaying associated infographics in an order based on the determined ranks.

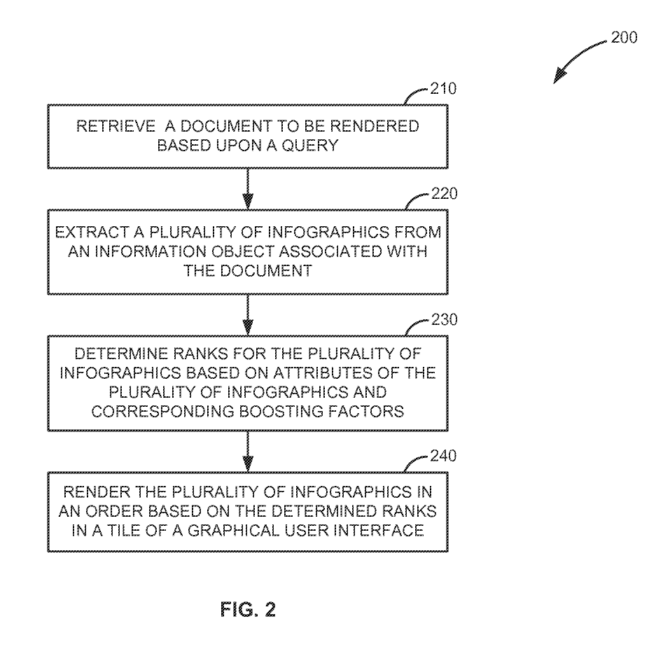

FIG. 2 is a flow diagram illustrating example process 200 to provide data visualization in a tile-based graphical user interface (GUI), according to an embodiment. Data visualization tools (e.g., data visualization software) can be provided to generate and display data visualizations. An example of data visualization tool is SAP® Lumira provided by SAP® SE. SAP® Lumira is a self-service solution that allows analysts and decision makers to access, transform, and visualize data. The SAP® Lumira desktop experience is used to prepare data from multiple sources, visualize it, and then compose stories from those visualizations that can be shared with other decision makers using SAP® Lumira server and cloud platforms which provide browser and mobile based experiences to further analyze data and collaborate with colleagues on datasets, stories, and other business intelligence artifacts.

In an exemplary embodiment, the documents, that are to be visualized, can be retrieved over a network from a data repository. Further, the documents are retrieved based upon a query to render relevant documents. For example, a user generates instructions or the query to retrieve the relevant documents for visualization and analysis in one embodiment, a user is provided an option to choose whether to visualize a list of relevant documents in the GUI or to visualize the data in the tile-based GUI.

A document listing module extracts a list of relevant documents from the data repository based upon the query. At 210, a document, from the list of relevant documents, to be rendered is retrieved at an infographics ranking module. The document can be a report, a dashboard or data visualizations such as a business intelligence (BI) report.

At 220, extract infographics from an information object associated with the document. In one exemplary embodiment, when the document is uploaded to the data repository, infographics or visualization snapshots of document are extracted and stored separately in the information object corresponding to the document. It is to be appreciated that the infographics are part of the information object, but not a part of document in the data repository. Therefore, it is not required to access the document to retrieve the infographics.

At 230, ranks for the infographics are determined based on attributes of the infographics and corresponding boosting factors (BF). For example, when the document includes hundreds of infographics or visualizations, ranks are determined for each infographics. Further, ranking is performed based on particular user context using attributes and corresponding BFs. The BFs are determined based on a number of attributes, Table 1 depicts the BFs corresponding to ten attributes associated with the document “sales analysis.”

TABLE 1

| SI. No. | BF | Attributes |
|---|---|---|
| BF[0] | 512 | Number of Attributes used in the visualization |
| BF[1] | 256 | Ranking of the attributes (Average ranking of |
| | | attributes) |
| BF[2] | 128 | Owner, if its owned by me, factor value = |
| | | sum of (discussions and views) |
| BF[3] | 64 | Number of discussions on the visualization |
| BF[4] | 32 | Number of views on the visualization |
| BF[5] | 16 | Timestamp of the last modification |
| BF[6] | 8 | Number of stories that visualization is part of |
| BF[7] | 4 | Custom visualization |
| BF[8] | 2 | Geo hierarchies |
| BF[9] | 1 | Timestamp of the last refresh |

In one exemplary embodiment, ranks for each infographics associated with the document “sales analysis” are determined using the BFs depicted in Table 1 and an equation depicted in Table 2.

```
TABLE 2
var TOTAL_FACTORS = 10;
var factorCount = 0;
var rank = 0;
  for(factorCount=0;factorCount<TOTAL_FACTORS;factorCount++);
  rank += BF[factorCount] * (factor_value[factorCount] ∥ 0);
}
```

At 240, the infographics are rendered in an order based on the determined ranks in a tile of the tile-based graphical user interface (GUI). In one embodiment, the tile based GUI includes a number of tiles and a tile is associated with a document. For example, when a list of ten relevant documents is extracted by a document listing module based on the request, ten tiles in the GUI are presented and each tile represents a document. Further, the tile displays the infographics associated with the document in the order based on the determined ranks. In one exemplary embodiment, the GUI for each document may be presented in a “tile view” or in a “full-screen view.” The user may switch between the GUI in the tile view and the GUI in full-screen view.

Therefore, the infographics associated with the document are stored separately in the information object and the document is visualized by rendering the infographics in the tile-based GUI based on the ranks of the infographics. Hence, the infographics are presented without opening the document and thus the performance involved in rendering relevant data and analyzing the data can be optimized.

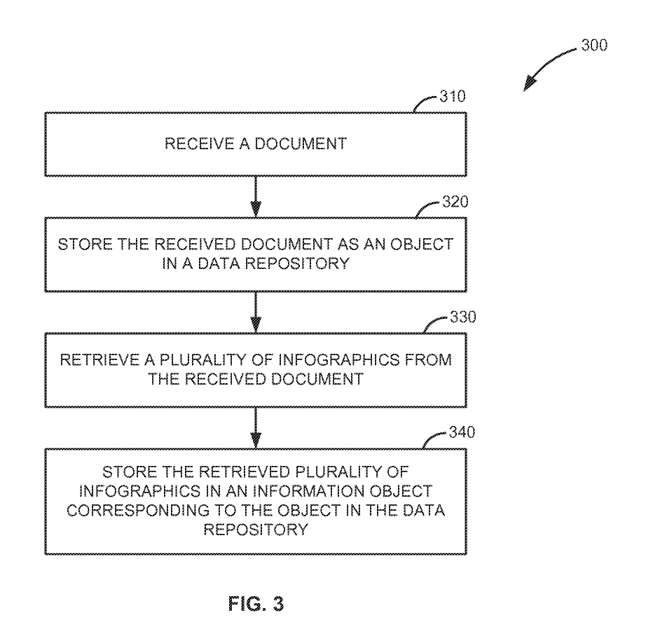

FIG. 3 is a flow diagram illustrating example process 300 to obtain infographics in an information object, according to an embodiment. At 310, a document is received. The data associated with the document may be connected and/or related according to any of a variety of contexts, such as, for example, a particular business issue or problem, a particular product or service, a particular organizational unit and/or portion of a business enterprise, across a particular position and/or user role found within the business enterprise, and other contexts.

In one exemplary embodiment, the document can include multiple visualizations to understand and analyze the data aimed at boosting performance by helping organization's executives and other end users to make more informed decisions. Further, the document may include data from internal sources and/or external sources. For example, the BI report includes historical information and new data gathered from source systems, enabling BI analysis to support both strategic and tactical decision-making processes.

At 320, the received document is stored as an object in the data repository. In one example context, the object represents a business object (BO). It is appreciated, however, that implementations of the present disclosure are applicable in other contexts.

At 330, infographics are retrieved from the received document. The information in the document may be presented in a variety of techniques and views, such as, but not limited to reports, tables, notes, graphs, and other views. In other words, the document includes multiple infographics or visualization snapshots representing the above mentioned contexts and such infographics are retrieved from the document.

At 340, the retrieved infographics are stored in an information object corresponding to the object in the data repository. Thereby the infographics are part of the information object corresponding to the object representing the document, but not a part of the object. Therefore, it is not required to open the document to obtain the infographics.

In one embodiment, the infographics in the information object are updated based on modification of the document. For example, when the document is refreshed and/or updated, the corresponding infographics in the information object will be updated accordingly. Further, when a new infographics is added to the document, the new infographics is added to the information object. When a particular infographic is deleted, then respective infographic also gets deleted from the information object. Therefore, the infographics in the information object are real time data.

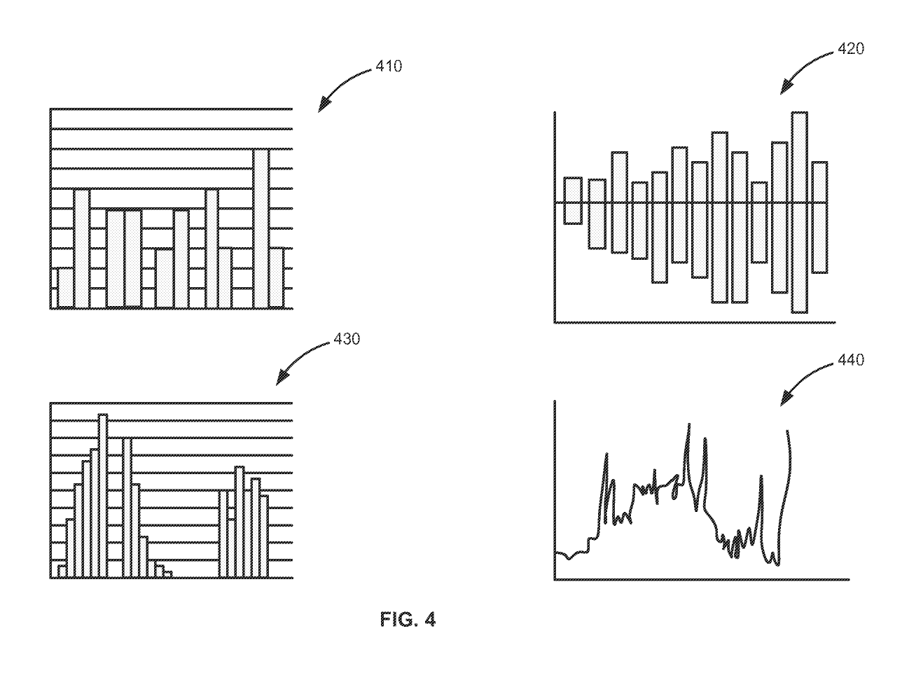

FIG. 4 is a schematic diagram illustrating exemplary infographics (e.g., 410, 420, 430 and 440) associated with a document, according to an embodiment. The infographics associated with the document “sales analysis” are depicted in FIG. 4. For instance, the document “sales analysis” includes four infographics such as “City wise sales” 410, “Delhi sales” 420, “Mumbai sales” 430 and “Bangalore sales” 440. In one exemplary embodiment, when the document “sales analysis” is stored in a data repository as an object, the four infographics (e.g., 410, 420, 430 and 440) are extracted and stored in the information object.

Further, when a request to render the document “sales analysis” is received, ranks for the infographics (e.g., 410, 420, 430 and 440) are determined based on attributes and associated boosting factors (BF) as depicted in Table 1. In the example, the three infographics include one common attribute. The infographic “City wise Sale” 410 has three more unique attributes, other three visualizations has three common attributes. Second infographics “Delhi sales” 420 is a part of three stories and remaining infographics are part of one story. Further, the third infographics “Mumbai sales” 430 has a custom chart. The forth infographics “Bangalore sales” 440 is based on the geo chart.

Based on the BFs depicted in Table 1 and the equation depicted in Table 2, Table 3 depicts rank of the infographics “City wise sales” 410, Table 4 depicts rank of the infographics “Delhi sales” 420, Table 5 depicts rank of the in “Mumbai sales” 430 and Table 6 depicts rank of the infographics “Bangalore sales” 440 for a timestamp of five days ago.

TABLE 3

| | Boosting | | City |
|---|---|---|---|
| | Factor | Value | wise sale |
| No. of attributes | 512 | 4 | 2048 |
| Ranking of attributes | 256 | 1.75 | 448 |
| Owner | 128 | 0 | 0 |
| Number of discussions | 64 | 0 | 0 |
| number of views | 32 | 0 | 0 |
| timestamp of last modification | 16 | 0 | 0 |
| number of stories | 8 | 1 | 8 |
| custom visualization | 4 | 0 | 0 |
| Geo hierarchy | 2 | 0 | 0 |
| Timestamp of last refresh | 1 | 0 | 0 |
| Total Rank of “City wise sales” 410 | | | 2504 |

TABLE 4

| | Boosting | | Delhi |
|---|---|---|---|
| | Factor | Value | sales |
| No. of attributes | 512 | 4 | 2048 |
| Ranking of attributes | 256 | 3.25 | 832 |
| Owner | 128 | 0 | 0 |
| Number of discussions | 64 | 0 | 0 |
| number of views | 32 | 0 | 0 |
| timestamp of last modification | 16 | 0 | 0 |
| number of stories | 8 | 3 | 24 |
| custom visualization | 4 | 0 | 0 |
| Geo hierarchy | 2 | 0 | 0 |
| Timestamp of last refresh | 1 | 0 | 0 |
| Total Rank of “Delhi Sales” 420 | | | 2904 |

TABLE 5

| | Boosting | | Mumbai |
|---|---|---|---|
| | Factor | Value | sales |
| No. of attributes | 512 | 4 | 2048 |
| Ranking of attributes | 256 | 3.25 | 832 |
| Owner | 128 | 0 | 0 |
| Number of discussions | 64 | 0 | 0 |
| number of views | 32 | 0 | 0 |
| timestamp of last modification | 16 | 0 | 0 |
| number of stories | 8 | 1 | 8 |
| custom visualization | 4 | 1 | 4 |
| Geo hierarchy | 2 | 0 | 0 |
| Timestamp of last refresh | 1 | 0 | 0 |
| Total Rank of “Mumbai Sales” 430 | | | 2892 |

TABLE 6

| | Boosting | | Bangalore |
|---|---|---|---|
| | Factor | Value | sales |
| No. of attributes | 512 | 4 | 2048 |
| Ranking of attributes | 256 | 3.25 | 832 |
| Owner | 128 | 0 | 0 |
| Number of discussions | 64 | 0 | 0 |
| number of views | 32 | 0 | 0 |
| timestamp of last modification | 16 | 0 | 0 |
| number of stories | 8 | 1 | 8 |
| custom visualization | 4 | 0 | 0 |
| Geo hierarchy | 2 | 1 | 2 |
| Timestamp of last refresh | 1 | 0 | 0 |
| Total Rank of “Bangalore sales” 440 | | | 2890 |

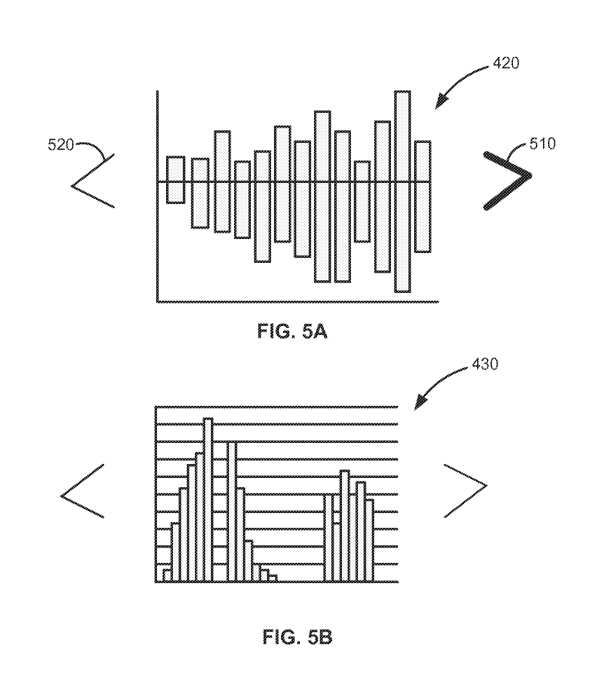

FIG. 5A is a schematic diagram illustrating an exemplary tile in a graphical user interface (GUI) displaying infographics based on ranks, according to an embodiment. FIG. 5B is a schematic diagram illustrating the exemplary tile in the GUI displaying infographics based on ranks, according to an embodiment. The GUI includes a tile representing a document “sales analysis.” in the example, ranks of four infographics associated with the document “sales analysis” as determined above are: rank of “City wise sales” 410 is 2504, rank of “Delhi sales” 420 is 2904, rank of “Mumbai sales” 430 is 2892, and rank of “Bangalore sales” 440 is 2890. Further, the four infographics are rendered based on their respective ranks. Since the infographic “Delhi sales” is of highest rank, the infographic “Delhi sales” is displayed first as shown in FIG. 5A. Therefore, data of the document “sales analysis” is visualized without opening the actual document.

In one exemplary embodiment, options are provided in the tile of the GUI to visualize subsequent and previous infographics based on the ranks of the infographics. For example, an option 510 is provided to visualize next ranked infographics. Accordingly, when the option 510 is selected, next ranked infographic “Mumbai sales” 430 is displayed as shown in FIG. 5B. Further, using options 510 and 520, the subsequent infographics are displayed. In one embodiment, the infographics are real time data. For example, when a particular infographic in the document is modified, the modification is reflected in the infographics stored in an information object and the same is rendered in the GUI.

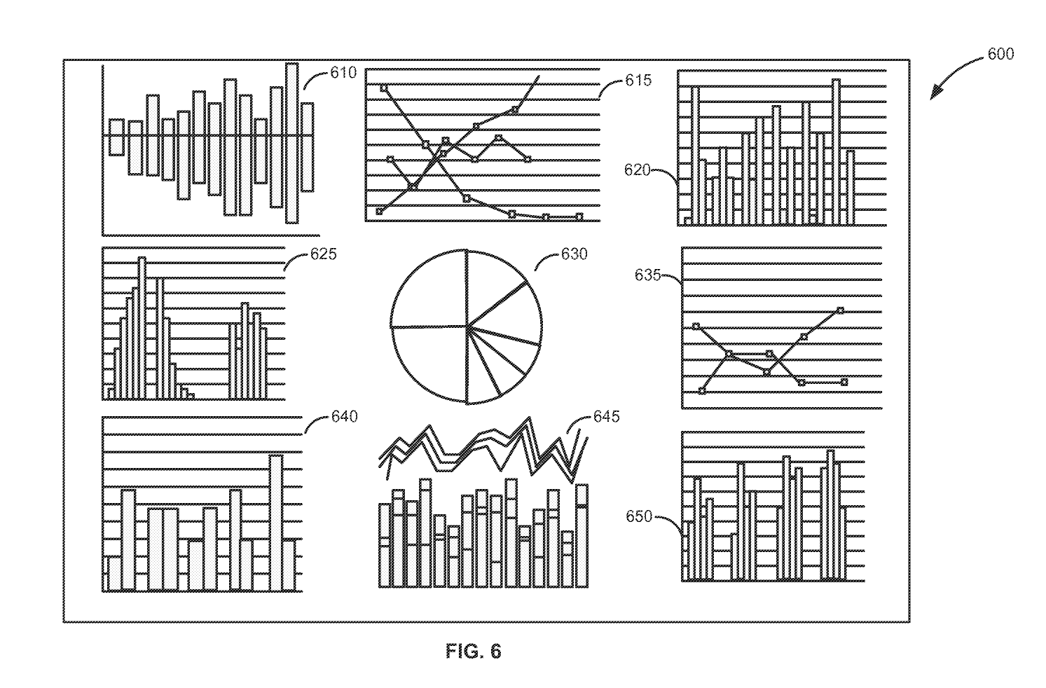

FIG. 6 is a schematic diagram illustrating exemplary graphical user interface (GUI) 600 displaying data based on a query, according to an embodiment. The GUI 600 can be the interface displayed by a computing system, with which a user can interact. The GUI 600 includes multiple tiles and each tile represents a document. For example, when nine documents are retrieved as relevant documents based on a request, nine tiles (e.g., 610, 615, 620, 625, 630, 640, 645 and 650) representing the relevant documents are displayed as shown in FIG. 6. Further, each tile displays infographics in an order based on ranks of the infographics.

The infographics may include graphs, bar charts, pie charts, line charts, data tables, and so on associated with the documents. Further, infographics may include labels to inform the user as to the nature of the data that is being represented by the infographics and infographics may be annotated in addition to the labels to convey additional information about the data.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

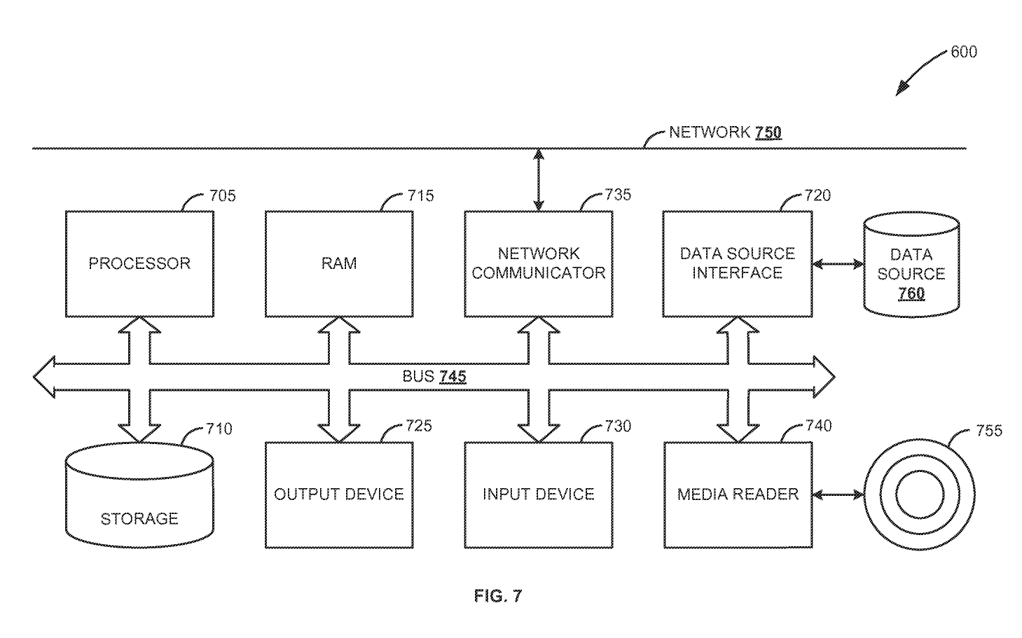

FIG. 7 is a block diagram of exemplary computer system 700, according to an embodiment. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least sonic instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. One or more of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiments are described herein for illustrative purposes, various equivalent modifications are possible within the scope of the embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to provide data visualization in a tile-based graphical user interface, comprising:
retrieve a document to be rendered based upon a query;
extract a plurality of infographics from an information object associated with he document;
determine ranks for the plurality of infographics based on attributes of the plurality of infographics and corresponding boosting values; and
render the plurality of infographics in an order based on the determined ranks in a tile of the tile-based graphical user interface

2. The computer implemented method of claim 1, wherein the document comprises data from internal sources and external sources of an organization.

3. The computer implemented method of claim 1, wherein the boosting factors are determined based on a number of attributes.

4. The computer implemented method of claim 1, wherein the tile comprises options to visualize subsequent and previous infographics based on the ranks of the infographics.

5. The computer implemented method of claim 1, wherein the document is stored as an object and the plurality of infographics associated with the document are stored in the information object corresponding to the object in a data repository.

6. The computer implemented method of claim 5, wherein storing the infographics in the information object comprises:
receiving the document;
storing the received document in the object;
retrieving the plurality of infographics from the received document; and
storing the retrieved plurality of infographics in the information object corresponding to the object in the data repository.

7. The computer implemented method of claim 6, further comprising:
updating the plurality of infographics in the information object based on modification of the document.

8. A computing system to provide data visualization in a tile-based graphical user interface comprising:
at least one processor; and
one or more memory devices communicative with the at least one processor, wherein the one or more memory devices store instructions to:
retrieve a document to be rendered based upon a query;
extract a plurality of infographics from an information object associated with the document;
determine ranks for the plurality of infographics based on attributes of the plurality of infographics and corresponding boosting values; and
render the plurality of infographics in an order based on the determined ranks in a tile of the tile-based graphical user interface.

9. The computer system of claim 8, wherein the document comprises data from internal sources and external sources of an organization.

10. The computer system of claim 8, wherein the boosting factors are determined based on a number of attributes.

11. The computer system of claim 8, wherein the tile comprises options to visualize subsequent and previous infographics based on the ranks of the infographics.

12. The computer system of claim 8, wherein the document is stored as an object and the plurality of infographics associated with the document are stored in the information object corresponding to the object in a data repository.

13. The computer system of claim 12, wherein storing the infographics in the information object comprises:
receiving the document;
storing the received document in the object;
retrieving the plurality of infographics from the received document; and
storing the retrieved plurality of infographics in the information object corresponding to the object in the data repository.

14. The computer system of claim 13, further comprising:
updating the plurality of infographics in the information object based on modification of the document.

15. A graphical user interface displayable on a computing system, comprising:
a plurality of tiles representing documents, wherein a tile displays a plurality of infographics associated with a document in an order based on ranks of the infographics; and
options to visualize subsequent and previous infographics based on the ranks of the infographics.

16. The graphical user interface of claim IS, wherein displaying the infographics in the tile comprises:
retrieving the document to be rendered based upon a query;
extracting the plurality of infographics from an information object associated with the document;
determining ranks for the plurality of infographics based on attributes of the plurality of infographics and corresponding boosting values; and
displaying the plurality of infographics in the order based on the determined ranks in the tile of the graphical user interface.

17. The graphical user interface of claim 15, wherein the tile comprises options to visualize subsequent and previous infographics based on the ranks of the infographics.

18. The graphical user interface of claim 15, wherein the document comprises data from internal sources and external sources of an organization.

19. The graphical user interface of claim 15, wherein the boosting factors are determined based on a number of attributes.

20. The graphical user interface of claim 15, wherein the document is stored as an object and the plurality of infographics associated with the document are stored in the information object corresponding to the object in a data repository.
